(19) United States
(12) Patent Application Publication
(10) Pub. No.: US 2005/0099286 A1
(43) Pub. Date: May 12, 2005

(54) Flasher for motor vehicles providing distinctive hazard-flash patterns to signal rapid deceleration and other hazards

(76) Inventor: John W. DeYoung, Lynden, WA (US)

Correspondence Address: John W. DeYoung, 318 Kwanzan Drive, Lynden, WA, 98264-9542, US

(21) Appl. No.: 11/015,919

(22) Filed: Dec. 20, 2004

Related U.S. Application Data
(63) Continuation of application No. 09/810,315, filed on Mar. 14, 2001, now Pat. No. 6,515,584.

(51) Int. Cl. B60Q 1/22

(52) U.S. Cl. 340/463; 340/468

(57) ABSTRACT

A flasher-control system for motor vehicles which automatically provides two different flash patterns for signaling with vehicle's turn-signal/hazard-signal lamps: (1) uniform patterns for turn signals, and (2) distinctive non-uniform sequences for hazard alerts The distinctive non-uniform, hazard-alert flash sequence is used: (a) to signal very rapid deceleration of a vehicle when triggered by a deceleration sensing means, and (b) to signal other hazards when activated by the driver. The purposes of the distinctive non-uniform, hazard-alert flash are, compared to conventional turn-signal-rate hazard flashers, to make hazard-alert signals readily distinguishable from turn signals and to make such signals more conspicuous, striking and attention getting and thus more effective in signaling hazards. A lamp-out detector is included which can be used with any number and combination of incandescent and LED lamps, including a vehicle with all LED signal lamps.

### CROSS REFERENCES

This application is a continuation of U.S. patent application Ser. No. 09/810,315 filed Mar. 14, 2001, U.S. Pat. No. 6,515,584.

### FEDERALLY SPONSORED RESEARCH OR DEVELOPMENT

Not applicable.

### REFERENCE TO COMPACT DISK APPENDIX

Not applicable.

### BACKGROUND OF THE INVENTION

This invention is a modification of the flasher described in my previous patent application, Series 09, Ser. No. 810315, now U.S. Pat. No. 6,515,584. The flasher described therein produced a distinctive non-uniform, hazard-alert flash pattern which will enable drivers of other vehicles to more readily distinguish hazard signals from turn signals. The distinctive non-uniform, hazard-alert flash also can greatly increase the effectiveness of hazard signals by making them more striking and attention getting compared to a standard, four-way flash.

Rapid-Deceleration Signal

My original device was intended to be an improved hazard alert flasher. It makes no provision for signaling rapid stops, such as hard-braking incidents. Incorporation into the original device of a means to sense very rapid deceleration could allow the hazard flasher to also be employed to provide an effective, high-visibility, attention-getting signal to warn following drivers that a vehicle is decelerating very rapidly.

Prior art contains numerous means for sensing and signaling rapid deceleration to help prevent collisions, dating at least as far back as 1945. So far as I know, none of these inventions has come into common use.

My U.S. Pat. No. 6,515,584, describes a turn-signal/hazard-signal pulse generator which automatically senses which signal is triggered and produces the desired flash pattern. For hazard signals, a distinctive non-uniform flash pattern produced, so that following drivers can more readily distinguish hazard signal patterns from uniform turn signal patterns, and to increase the effectiveness of hazard signals by making them more conspicuous and striking. Prior art had not shown the use of such a non-uniform flash pattern automatically produced when a hazard is signaled. By also utilizing the same distinctive non-uniform, hazard-alert flash pattern to signal rapid deceleration, as this modification does, there would be one consistent hazard-flash pattern, whether to signal “ordinary” hazards manually activated by the driver or to signal rapid deceleration hazards automatically triggered by an accelerometer. If my flasher comes into common use, I expect that motorists would become familiar with the hazard-alert flash pattern and would quickly recognize that it signals a hazard ahead which requires their immediate attention, be it an “ordinary” hazard or a rapidly-decelerating vehicle.

Prior art does not show the use of the same distinctive non-uniform flash pattern to signal both rapid-deceleration hazards and other types of hazards.

U.S. Pat. No 6,411,204 describes a deceleration warning using lights which flash and vary in intensity. A flashing center-mounted brake light is disclosed in U.S. Pat. No. 6,160,476 and in U.S. Statutory Invention Registration No H2,001. U.S. Pat. No. 6,023,221 discloses the use of hazard-warning lights to warn of rapid deceleration. U.S. Pat. No. 5,309,141 discloses a rapidly flashing xenon bulb. U.S. Pat. No. 5,150,098 discloses a variable-flashing separate lamps dedicated to brake signaling. U.S. Pat. No. 3,559,164 provides for a deceleration warning by flashing turn-signal lamps.

Related Art

| U.S. Pat. No. | | |
|---|---|---|
| 2474610 | May 1945 | Wunsch |
| 3559164 | January 1971 | Bancroft, et al. |
| 5148147 | September 1992 | Kobres |
| 5150098 | September 1992 | Rakow |
| 5309141 | May 1994 | Mason, et al. |
| 5504472 | April 1996 | Wilson |
| 5828319 | October 1998 | Tonkin, et al. |
| 5909173 | June 1999 | Mason, et al. |
| 6023221 | February 2000 | Michelott |
| 6081188 | June 2000 | Kutlucinar, et al. |
| 616047 | December 2000 | Ponziani |
| 6225896 | May 2001 | Sendowski |
| 6249219 | June 2001 | Perez, et al. |
| H2001 | November 2001 | Pinkus |
| 6323766 | November 2001 | Bartlett, et al. |
| 6411204 | June 2002 | Bloomfield, et al. |
| 6424256 | July 2002 | Ryder |

Lamp-Out Signal

As it was described in the original patent, my flasher would not provide an indication to the driver if one of the turn-signal lamps was not functioning. That application was directed primarily toward combination turn-signal/hazard-signal flashers for trucks and buses. A lamp-out signal is not required in large vehicles, but a lamp-out signal is required by FMVSS 108 S5.5.6 for automobiles and other small vehicles.

Prior art discloses numerous techniques to comply with FMVSS 108 S5.5.6. As far as I know, none of the prior art discloses a single indicator light for lamp outage of any of the signal lamps whether in turn or hazard mode. The flasher described herein indicates a lamp out in either mode.

The lamp-out feature of this flasher works with all incandescent or all LED lamps or any combination of incandescent and LED. I am not aware that any of the prior art would work with all LED signal lamps.

Related Art

| U.S. Pat. No. | | |
|---|---|---|
| 5075814 | October 1991 | Onan, et al. |
| 5072210 | December 1991 | Kimmelman |
| 5144282 | September 1992 | Sutterlin, et al. |
| 5223820 | June 1993 | Sutterlin, et al. |
| 5235317 | August 1993 | Sutterlin, et al. |
| 5309142 | May 1994 | Fritz |
| 5515028 | May 1996 | Dittmar |
| 5801623 | September 1998 | Chen, et al. |

### BRIEF SUMMARY OF THE INVENTION

Two features are here added to the flasher as it is described in my U.S. Pat. No. 6,515,584:
(1)The addition of a hazard-alert feature to signal rapid deceleration, using the same distinctive flash pattern as is used to signal other hazards.
(2)The inclusion of a lamp outage detection system to comply, in a single combination flasher, with the requirement for small-vehicle turn-signal flashers for “an illuminated pilot indicator” as provided in FMVSS 108 S5.5.6, (a) a system effective in either turn-signal or hazard-signal mode, and (b) a system which works in a vehicle with all LED signal lamps, all incandescent lamps, or a combination of LED and incandescent lamps.

### BRIEF DESCRIPTION OF THE DRAWINGS

FIG. 1 is a block diagram of the device as installed in a vehicle.

FIG. 2 is a schematic drawing of the wiring of the LED lamp-out “pilot indicator” device with three parts:
2a. Lamp and sensor circuit
2b. Reference voltage circuit
2c. Indicator circuit.

FIG. 3 is a schematic of the pulse generator showing modifications from my U.S. Pat. No. 6,515,584.

### DESCRIPTION OF THE INVENTION

This variation of the flasher described in U.S. Pat. No. 6,515,584 includes two modifications:

(1) It provides a lamp-out detector circuit for each turn-signal/hazard-alert lamp. If any lamp fails to function as it should when either the turn- or hazard-signal switch is closed, an LED pilot indicator light will signal the operator. If a lamp does not function when a turn signal is called for, the microprocessor of the flasher pulse control can be programmed to cause a significant change in the flash rate of the signal lamps to comply with the requirement of SAE Standard J588e, as incorporated in FMVSS 108 S5.5.6. The flash rate would not change when a hazard is signaled and a lamp fails.

(2) A rapid-deceleration signal has been added to the original design also. When the microprocessor receives an input from a deceleration sensing system, the same distinctive non-uniform, hazard-alert pulse is generated as when the manual hazard-alert switch is closed. The standard turn-signal/hazard-alert lamps are activated and the distinctive hazard-alert flash pattern warns following drivers of a hazard ahead, in this case a rapidly-decelerating vehicle.

The distinctive hazard-alert signal can be used on vehicles with a single filament providing brake, turn, and hazard signals, but in that situation, the hazard signal can override the brake signal. I anticipate that my system will be used mostly on automobiles, trucks and buses with a rear-signal light configuration consisting of brake lamps separate from the combination turn-signal/hazard-alert lamps. With such separate lamps, the rapid-deceleration signal would not interfere with the brake signal.

The distinctive flash used for hazard alerts consists of a series of short flashes followed by a longer pause. Under present regulations the number of flashes is limited to 120 per minute To comply with the regulation as interpreted by the Chief Counsel of the National Highway Safety Administration, one of our prototypes is programmed to provide a repeating hazard-flash pattern as 200 ms ON, 250 ms OFF, 200 ms ON, 250 ms OFF, 200 ms ON, 850 ms PAUSE.

FIG. 4 shows the prototype hazard-flash patters diagrammatically. The hazard-alert flash shown as (3)200 ms ON, (2)250 ms OFF with 850 ms PAUSE complies with the current regulations as interpreted by the chief counsel of the NHTSA. The faster rates shown do not so comply. A pattern with (3)167 ms ON, (2)200 ms OFF, 600 ms PAUSE, like the second example in FIG. 4, does provide a rate of flash which, if timed for a minute, would be within the rate of 120 flashes per minute, the maximum allowed by the regulations, however this is interpreted by the chief counsel as too fast. The third flash pattern shown in FIG. 4 is significantly faster than current regulations allow. It is, however, much more striking and more distinctive (compared to turn signals), and if NHTSA wants an effective signal for stopped, slow-moving, or rapidly-decelerating vehicles, it would seem they should give consideration to modifying the regulation to allow such a flash pattern.

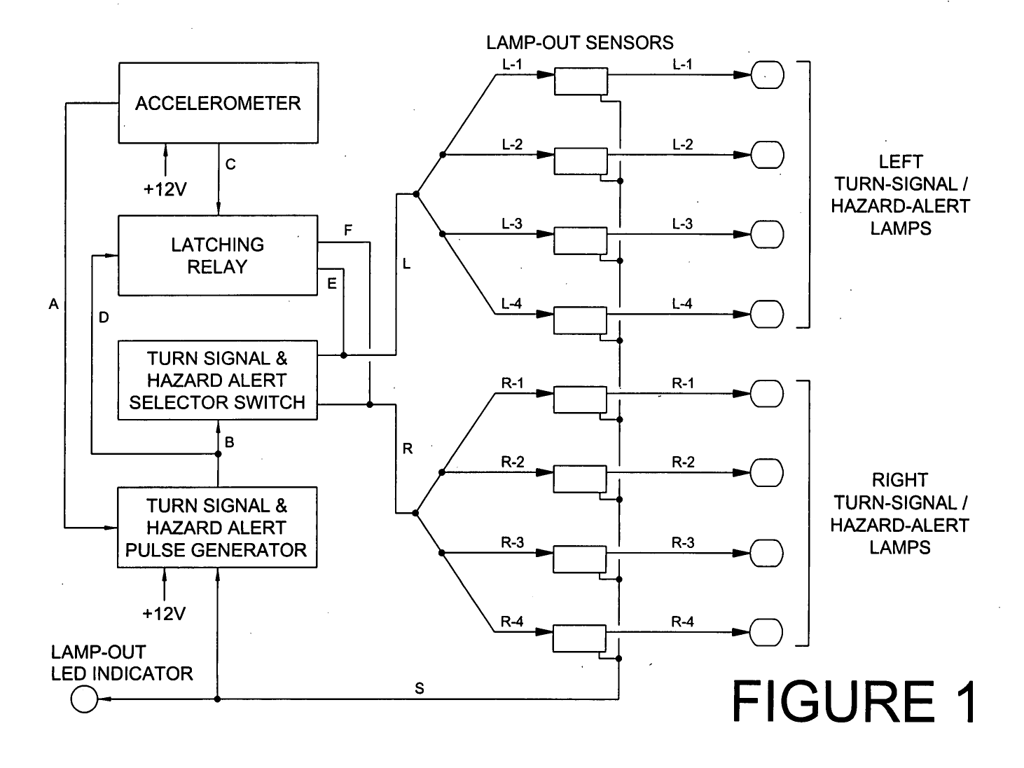

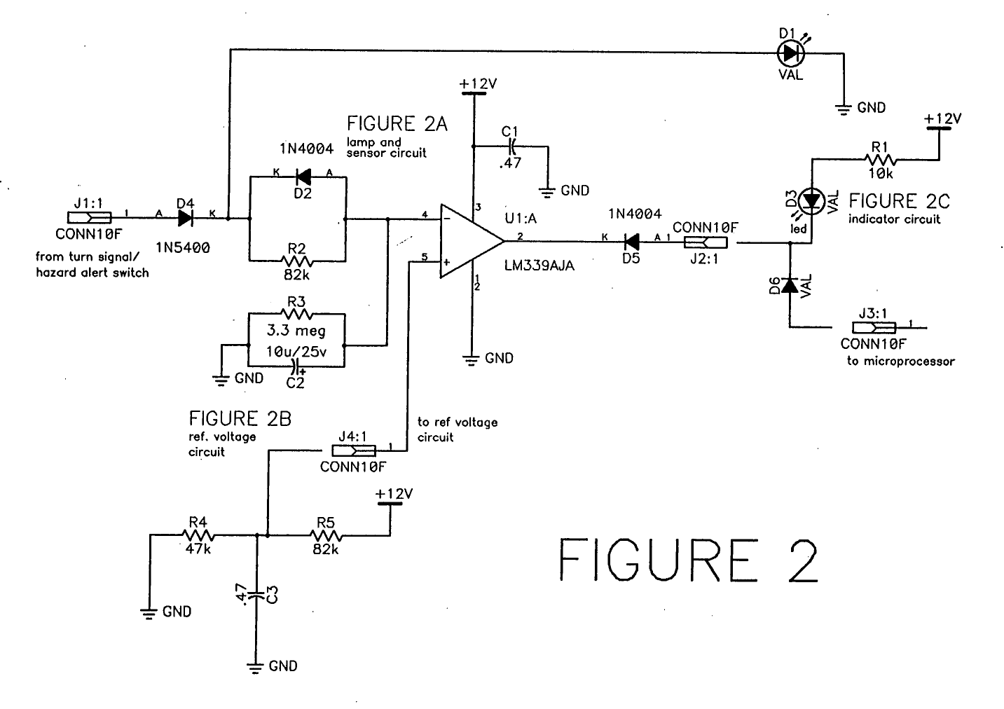

FIG. 1 is a block diagram showing the relationship of the parts of the flasher system including the additions to my U.S. Pat. No. 6,515,584. The pulse generator produces a standard uniform-flash pattern when the turn-signal control is activated, and it produces a distinctive non-uniform flash pattern when the hazard-signal control is activated as in the original design. The revised configuration of my flasher adds the rapid deceleration alert feature. An accelerometer is added to detect rapid deceleration, such as would occur with very hard braking. When the accelerometer is activated by a very rapid deceleration, the microprocessor of the turn-signal/hazard-alert pulse generator senses, via Line A, the accelerometer activation and causes the pulse generator to produce in Line B the same non-uniform flash-pulse pattern as is used for hazard alerts. At the same time, activation of the accelerometer causes, via Line C, the latching relay to close. The hazard-alert pulse is transmitted from Line B to the latching relay via Line D. With the pulse generator producing a hazard-alert pulse and the latching relay closed, the hazard-alert pulse is transmitted from the latching relay, via Lines E and F, to Lines L and R and thus to all of the left and right signal lamps. All signal lamps produce the distinctive, non-uniform, hazard-alert flash pattern to warn other drivers of the vehicle's very rapid deceleration.

FIG. 1 also shows the lamp-out sensor feature. The principal purpose of this lamp-out warning system is to provide such warning for LED signal lamps The diagram shows four left- and four right-turn signal lamps. Any number of lamps can be accommodated. Each lamp has a separate lamp and sensor circuit. When a left turn is signaled, a pulse is transmitted to Lines L-1, L-2, L-3, and L-4. If any of the left-turn signal lamps does not light, the lamp-out sensor for that lamp will activate Line S. When Line S is activated, the lamp-out LED indicator is lit to inform the operator that a lamp is out. In the turn-signal phase, activation of Line S by one of the lamps not lighting also activates the microprocessor of the pulse generator to change the turn-signal-flash rate to comply with FMVSS Standard 108 S5.5.6. The result is the same when a right turn is signaled with a lamp out.

In the hazard-signal phase, when a lamp is out, Line S is activated and the lamp-out LED indicator is lit to inform the operator, but the microprocessor does not change the hazard-flash rate or pattern

FIG. 2 shows a three part schematic diagram for the LED lamp-out signal device. The system is designed to function with LED lamps, but it would work if all or a portion of the lamps were incandescent.

There is a separate wire to each turn-signal/hazard-alert lamp. Each such wire is equipped with a lamp-out sensor circuit, so that there is one sensor circuit for each turn-signal/hazard-alert lamp. FIG. 2A shows only one such lamp and sensor circuit. A vehicle would have only one reference-voltage circuit (FIG. 2B) and one indicator circuit (FIG. 2C).

In FIG. 2, when a voltage pulse is present in the wire from the turn signal switch, the pulse passes through Diode D4 and to the LED signal lamp, D1. The voltage pulse also passes through Resistor R2 and partially charges Capacitor C2.

When the voltage stops, any charge in Capacitor C2 exceeding the minimum required to light the LED lamp passes through Diode D2 and through LED signal lamp D1 to be discharged to ground. Thus while the LED signal lamp is flashing, the capacitor and the sensor-circuit charge remains at the minimum required to light the LED signal lamp. However, if the turn or hazard signal is on and the lamp circuit is open, e.g., with a broken wire or bad lamp, Capacitor C2 cannot be discharged through the LED signal lamp In that situation, each additional pulse further charges Capacitor C2 to a voltage higher than the minimum required to light the LED lamp. Capacitor C2 is connected to Comparator U1:A at Pin 4. Pin 5 of Comparator U1:A is connected to the reference voltage circuit. When an LED signal lamp fails, the voltage at Capacitor C2 is driven higher than the setting of reference voltage circuit. When the voltage at Pin 4 of Comparator U:1 A exceeds the reference voltage at Pin 5, the comparator is triggered, so that Pin 2 of Comparator U1:A grounds the indicator circuit. When the indicator circuit is grounded, Indicator LED Diode D3 is lit providing a lamp-out signal to the operator. When the turn or hazard signal is switched off, the Lamp-out Indicator LED stays lit for approximately 30 seconds until Capacitor C2 is discharged through Resistor R3.

Our prototype is designed to light the Lamp-out Indicator LED in approximately three pulses to Capacitor C2 when a signal-lamp circuit is open. The reference-voltage circuit in our prototype is designed to provide a reference voltage of 7 volts. Seven volts was selected, because, at that voltage, currently-available truck LED lamps which we tested begin to conduct. A higher reference-voltage would be used for lamps with higher minimum-conducting voltage.

The use of an LED indicator to signal a lamp outage provides an advantage over the conventional lamp-out approach in that it can signal the operator that a lamp is out without disabling the still-working lamps. However this signal, by itself, would not provide a “light flashing at the same frequency as the signal lamps” as described in SAE Standard J588e, which is referenced in FMVSS 108S5.5.6. This regulatory standard is probably anachronistic, but if it be necessary to comply with this requirement, the microprocessor in the pulse generator can be programmed to change the turn-signal pulse to a faster rate when the indicator circuit is grounded. The microprocessor, would be programmed, to not change the normal hazard-flash timing when a hazard is signaled and there is a lamp out,

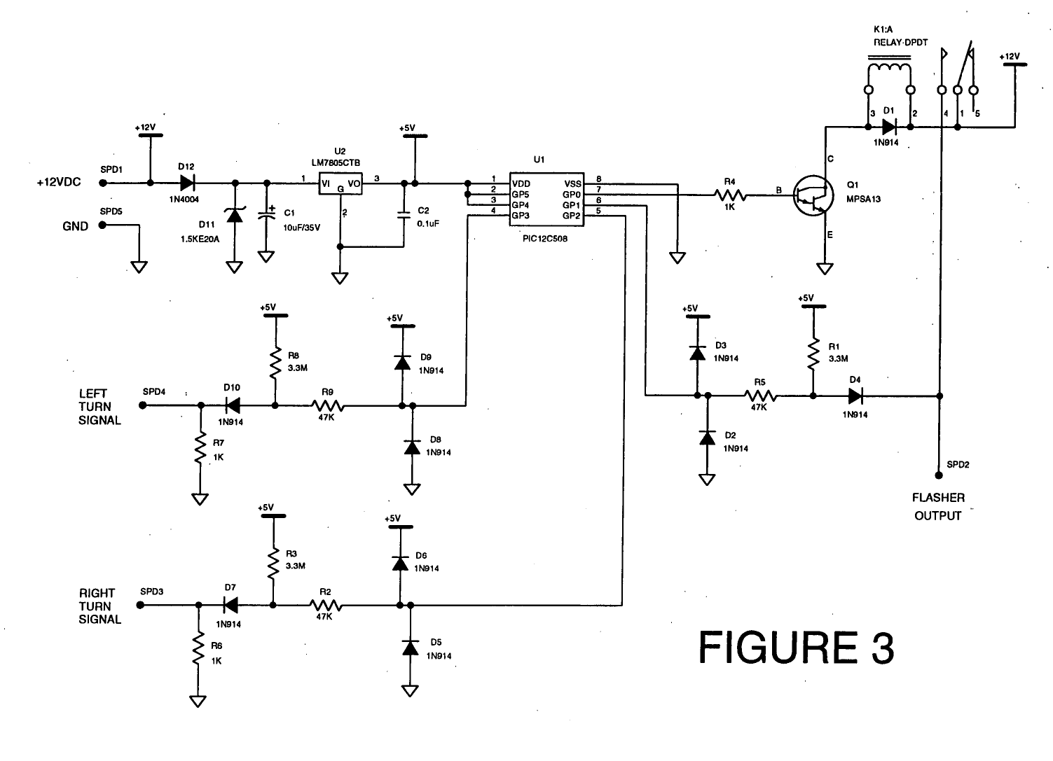

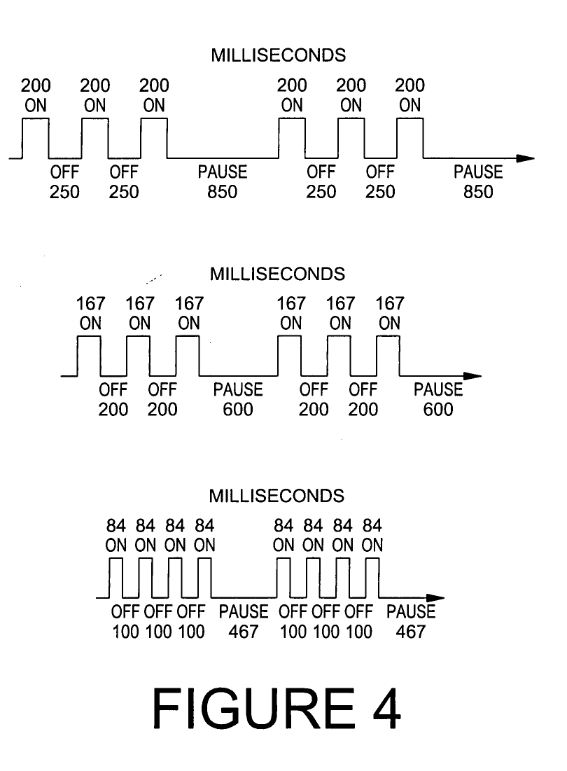

FIG. 3 is a schematic drawing of the pulse generator from my U.S. Pat. No. 6,515,584 with revisions.

One revision is the addition of two resistors labeled in FIG. 3 as R6 and R7. These resistors are located in the right- and left-turn-signal sensor lines respectively. These resistors provide the ground which the microprocessor senses to start the pulse generator pulsing. Said ground is sensed through the flasher output line when either the turn-signal switch or the hazard-alert switch is closed. This means of grounding is necessary when all signal lamps are LED's, because a sensing ground is not available through LED lamps as it would be through incandescent lamps. The previous design relied on grounds being sensed by the microprocessor through incandescent lamps as the trigger to begin pulse generation and to determine the pattern and rate of flash.

The second revision shown in FIG. 3 is an increase in the resistance of three resistors, those designated in FIG. 3 as R1, R3, and R8. The value of these resistors was changed to facilitate the functioning of lamp-out signal when signal lamps are LED's.

1. A hazard-warning and deceleration-warning system for highway vehicles, which automatically flashes the vehicle's turn-signal/hazard-signal lamps in a distinctive non-uniform pattern when the hazard-signal system is triggered; the same distinctive non-uniform flash pattern being produced in either of two manners: (1) when the flasher-control device is manually triggered by the vehicle operator to signal a hazard, or (2) when the flasher-control device is triggered, without participation by the operator, to signal rapid deceleration by a sensing means which senses rapid deceleration of the vehicle; which distinctive non-uniform flash pattern consists of repeating sequences, each sequence being made up of a number of brief flashes separated by short off-times all followed by a longer pause, a flash pattern readily distinguishable from the steady, uniform flash pattern of a turn signal.

2. A system, as in claim 1, in which the hazard/deceleration-alert flasher control device is a combination device which also generates turn-signal flash patterns when the turn-signal switch is closed.

3. A system, as in claim 1, in which one deceleration-sensing means is a digital accelerometer.

4. A system, as in claim 1, in which one deceleration-sensing means is an antilock-brake-control circuit.

5. A system, as in claim 1, in which one deceleration-sensing means senses the pressure on a vehicle's hydraulic-brake fluid.

6. A system, as in claim 1, in which one deceleration-sensing means senses the pressure on a truck's air-brake-control-line air pressure.

7. A system, as in claim 1, in which one deceleration-sensing means is the vehicle's control circuit for air-bag deployment.

8. A system, as in claim 1, in which one deceleration-sensing means is the vehicle's control circuit for seat-belt tightening.

9. A system, as in claim 1, in which one deceleration-sensing means is the output of the speedometer system's magnetic sensor.

10. A system, as in claim 1, in which the distinctive hazard-alert flash pattern consists in each sequence of two brief flashes separated by a short off-time and followed by a longer pause.

11. A system, as in claim 1, in which the distinctive hazard-alert flash pattern consists in each sequence of three brief flashes separated by two short off-times and followed by a longer pause.

12. A system, as in claim 1, in which the distinctive hazard-alert flash pattern consists in each sequence of four brief flashes separated by three short off-times and followed by a longer pause.

13. A system, as in claim 1, in which the distinctive hazard-alert flash pattern consists in each sequence of five brief flashes separated by four short off-times and followed by a longer pause.

14. A turn-signal hazard-signal system which detects that an LED signal lamp is failing to function, by means of a sensor circuit and a reference circuit; so that when a turn signal or hazard signal is on and an LED lamp fails to function, said sensor circuit builds voltage in a capacitor to a level greater than such voltage would build if the LED signal lamp were functioning; said sensor circuit being connected through a comparator to a reference-voltage circuit with the reference voltage set higher than the minimum-conducting voltage of the LED signal lamp, so that when the sensor-circuit voltage exceeds the reference voltage, the comparator triggers an indicator circuit to indicate to the operator that a signal lamp is not functioning.

15. A turn signal flasher system, as in claim 14, in which a single pilot indicator alerts the driver of a signal-lamp outage while the signal lamps can be flashed at their normal rate when a lamp is not functioning.
